(19) United States
(12) Patent Application Publication
(10) Pub. No.: US 2026/0326968 A1
(43) Pub. Date: Oct. 22, 2026

(54) SLEEVE WITH TEARING AID

(71) Applicant: Henkel AG & Co. KGaA, Düsseldorf (DE)

(72) Inventors: Peter Rushe, Düsseldorf (DE); Karsten Wolf, Wuppertal (DE); Kai Ruthe-Steinsiek, Düsseldorf (DE); Gerhard Josef Theumert, Meerbusch (DE)

(21) Appl. No.: 19/695,106

(22) Filed: Jun. 2, 2026

Related U.S. Application Data
(63) Continuation of application No. PCT/EP2024/083508, filed on Nov. 26, 2024.

(30) Foreign Application Priority Data
Dec. 7, 2023 (EP) 23214924.5

(51) Int. Cl. B65D 3/26; B31B 70/14; B65D 3/04; B65D 25/20

(52) U.S. Cl. CPC B65D 3/267; B31B 70/14; B65D 3/04; B65D 25/205

(57) ABSTRACT

The invention relates to a sleeve (1) for receiving a filling product, wherein the sleeve (1) has a proximal end (2) and a distal end (4), as well as a sleeve wall (5) extending between the proximal end (2) and the distal end (3) and delimiting a receiving space (4) for the filling product, wherein the sleeve wall (5) comprises an inner side (6) facing the receiving space (4) and an outer side (7) facing away from the receiving space (4), and wherein the sleeve (1) is produced as a wound sleeve made of a material comprising fibers, characterized in that the sleeve (1) comprises a tearing aid in the form of a material weakening (8) that extends from the distal end (3) into the sleeve wall (5). The invention further relates to a method for producing such a sleeve (1).

### DESCRIPTION

The invention relates to a sleeve for receiving a filling product. The invention also relates to a method for producing such a sleeve.

For professional applications and private use, various viscous materials such as silicone, acrylic and adhesives are supplied as standard in cartridges from which the material can be dispensed using a cartridge gun. Commercially available cartridges are often made of thick-walled plastics material.

In the wake of increased environmental and sustainability awareness, efforts are increasingly underway to replace thick-walled plastics cartridges with a combination of film bags that hold the viscous material and sleeves that hold the film bags and are made of a more sustainable and easily recyclable material, such as cardboard.

For example, DE 91 16 065 describes a device for processing materials packaged in film tubes, in which a film tube filled with a viscous material is received in an outer sleeve spirally wound from a plurality of paper layers, which in turn can be inserted into a conventional cartridge gun. The plastics material content of such systems is significantly reduced compared to conventional cartridges. After being emptied, the outer sleeve can be separated from the film bag and both components can be fed into the respective recycling streams.

In terms of efficiency and user-friendliness, it is necessary that the plastics material and paper components can be separated from each other as completely and easily as possible. This is true in particular for applications in craft businesses and on construction sites, where such cartridges are used in large numbers and a correspondingly large amount of waste is generated. Only if the plastics material and paper components can be separated quickly and without great effort, one can assume that the majority of users will do so.

For this purpose, solutions are known, for example from EP 3 936 455 B1, in which a tear line or a tear strip is provided in the circumferential direction of the sleeve. By cutting the sleeve along the tear line or tear strip, the sleeve can be separated into a proximal portion and a distal portion, wherein the larger of the two portions can subsequently be provided for paper recycling, while the smaller portion of the sleeve usually remains connected to the emptied foil bag, the piston and the nozzle element of the cartridge and can be disposed of with the residual waste.

A disadvantage of this solution is that the smaller portion of the sleeve cannot be separated from the emptied foil bag, the piston and the nozzle element, or can be so separated only with difficulty, and is therefore generally lost for paper recycling.

In addition, the introduction of a tear line or two tear lines delimiting a tear strip in the circumferential direction of the sleeve requires effort and sometimes carries the risk that the sleeve will be deformed during this process.

The present invention therefore has the object of providing a sleeve for receiving a filling product which can be separated particularly easily after emptying and at the same time can be produced in a simple manner. A further object of the invention is to propose a method for producing such a sleeve.

This object is achieved by a sleeve having the features of claim 1 and by a method having the features of claim 11.

Advantageous embodiments and further embodiments of the invention are the subject matter of the dependent claims.

According to claim 1, the invention relates to a sleeve for receiving a filling product, wherein the sleeve has a proximal end and a distal end and a sleeve wall extending between the proximal end and the distal end and delimiting a receiving space for the filling product, wherein the sleeve wall comprises an inner side facing the receiving space and an outer side facing away from the receiving space, and wherein the sleeve is produced from a material comprising fibers. The invention is characterized in that the sleeve comprises a tearing aid designed as a material weakening, which extends from the distal end into the sleeve wall.

In other words, the invention provides a tearing aid for easier tearing open of the sleeve and thus for easier separation of the sleeve from plastics material components arranged in the sleeve, for example an emptied film tube, wherein this tearing aid does not extend in the circumferential direction of the sleeve, but rather extends, starting from the distal end of the sleeve, into the sleeve wall. The tearing aid is designed as a material weakening in the material of the sleeve wall.

According to the invention, the sleeve is made of a material comprising fibers. For example, it can be made from a material based on plant fibers, in particular paper or cardboard.

In the context of the invention, the proximal end of the sleeve is generally understood to mean the discharge end of the sleeve, i.e., the end through which the filling product stored within the sleeve is discharged. Correspondingly, the distal end is generally understood to be the end of the sleeve opposite the proximal end.

The sleeve is made as a winding core from a material containing fibers, for example paper or cardboard. In winding cores, a strip of paper or cardboard is wound in several layers in a spiral and glued together to form the sleeve. The abutting edge at which the various winding layers of the paper or cardboard strip meet and which extends spirally over the length of the core is also referred to below as the spiral line.

The material weakening provided according to the invention, which extends from the distal end of the sleeve into the sleeve wall, serves as a starting aid for tearing open the sleeve. In this process, the material of the core wall is first torn by a user, starting at the weakening point, until the resulting tear line meets the spiral line of the winding core. The sleeve can then be easily separated along the spiral line by further pulling on the paper or cardboard strip. The spiral line here acts as a predetermined breaking point which can be broken by applying a small amount of force. In particular, it is possible in this way to separate the sleeve from the distal end to the proximal end and subsequently to separate the entire material of the sleeve from components made of other materials, such as a film tube, a piston and/or a nozzle tip. All of the sleeve material can therefore be provided for paper recycling. The material weakening is designed in such a way that it does not completely coincide with the spiral line in any case.

According to one embodiment of the invention, the material weakening extends from the distal end substantially in a direction parallel to the longitudinal axis L of the sleeve over a length of 0.5 cm to 1.2 cm. Therefore, only a comparatively short length of material weakening is required in order to be able to completely tear and separate the material of the sleeve wall.

One embodiment of the invention provides that the material weakening is designed as an incision which extends substantially in a direction parallel to the longitudinal axis L of the sleeve. In other words, using a suitable cutting tool, such as a knife or a saw blade, a short cut, for example about 1 cm long, is made in the sleeve wall starting from the distal end. In general, it is not necessary to specially align the sleeve in the circumferential direction for the cutting step. Rather, the cut can be made at any point along the circumference of the sleeve. Depending on the orientation of the sleeve, it is possible that the cut made already meets the spiral line, which makes it particularly easy to tear open the sleeve. But even in cases where the cut does not directly meet the spiral line, the incision makes it easier to tear the core material so that the material can easily be separated in the manner described above. The width of the incision can range from approximately 0.1 mm to 0.8 mm. In principle, it is desirable to make the cutting width as narrow as possible in order for example to minimize the risk of moisture penetrating into the material of the sleeve wall via the cut edges.

In principle, the material weakening can also extend at a certain angle to the longitudinal axis L of the sleeve. In addition, the material weakening can also be made as a perforation.

One embodiment of the invention provides that the distal end of the sleeve is covered by a material portion which lies against both a portion of the inside and a portion of the outside of the sleeve wall, wherein the material weakening is formed both in the sleeve wall and in the material portion. Such material portions, for example made of paper, are used to protect the end abutting edges of the sleeve from the penetration of moisture into the material of the sleeve wall, since penetrating moisture causes the pulp fibers in the paper material to swell. This can cause the sleeve to deform, lose its geometry and stability, and possibly become unusable. By covering the abutting edges, in particular the abutting edge at the distal end of the sleeve, with a material portion, the penetration of moisture can be prevented or at least reduced for a significant period of time.

Such a material portion can, for example, be strip-shaped, cover at least one abutting edge of the sleeve and extend over a maximum of 10% of the length of the sleeve, wherein the material portion extends in a narrow region adjacent to the abutting edge both along the inside and along the outside of the sleeve wall. It can be provided that the material portion is glued to the inner side and/or the outer side of the sleeve wall, optionally only at certain points.

The material weakening is formed both in the sleeve wall and in the material portion. In other words, in the production of such a sleeve, the material portion is first applied to the sleeve so as to cover the abutting edge and then the material weakening, for example in the form of an incision, is introduced into the composite of the sleeve wall and the material portion as described above.

An alternative and particularly efficient design variant in terms of production technology provides that the material portion substantially completely covers the outside of the sleeve wall, wherein the material portion is printed at least in some regions and has the function of a label. Such a material portion extends over the entire length of the sleeve and is guided over the two abutting edges of the sleeve into the receiving space in such a way that it at least partially abuts the inside of the sleeve wall. An advantage of this design is that by placing the printed material portion against the sleeve, both the abutting edge protection and the label carrying the product information are applied in a single production step. The material weakening is introduced into the composite of the sleeve wall and the material portion after the material portion has been applied.

In an alternative embodiment of the invention, the material weakening is formed as a recess in the sleeve wall, wherein the recess is delimited by two edge portions which extend spaced from one another and at different angles from the distal end into the sleeve wall such that they meet at a point P, wherein the point P has a maximum distance of 1.2 cm from the distal end. In this design, the material weakening is not formed as a narrow incision but as a small, flat material recess in the sleeve wall. The recess can be formed for example by making two incisions in the sleeve wall, starting from the distal end and meeting at a point P, so that a substantially triangular region is cut out of the sleeve wall. The recess can also be formed by punching. The point P has a maximum distance of 1.2 cm from the distal end. The two edge portions can have a distance d of 0.3 cm to 0.8 cm from each other at the distal end.

According to one embodiment, the distal end of the sleeve, which is provided with a material weakening formed as a recess, is covered by a material portion which rests both on a portion of the inside and on a portion of the outside of the sleeve wall, wherein the material weakening is formed only in the sleeve wall and the material portion covers the distal end of the sleeve provided with the material weakening.

In other words, it can also be provided in this embodiment that a material portion is applied as abutting edge protection, in particular to the distal end of the sleeve, but in this case the material weakening is formed only in the sleeve wall and not in the material portion. Otherwise, there would be a risk that under unfavorable ambient conditions too much moisture would be introduced into the material of the sleeve wall in the edge regions bordering the recess and exposed as cut edges. In this embodiment, the recess is thus completely covered by the applied material portion, wherein tearing of the material of the sleeve wall, including the overlying material portion in the region of the recess, is possible without difficulty.

It can be provided according to the invention that the sleeve has a marking indicating the tearing aid. This is particularly advantageous for embodiment variants in which the material weakening is covered by a portion of material and is not easily visible. But even in designs where the material weakening is designed, for example, as an incision penetrating the sleeve wall and the material portion, a marking can indicate the tearing aid. Such a marking can for example be arranged on the inside of the sleeve wall directly on the material of the sleeve wall or on the material portion covering the distal end of the sleeve adjacent to the material weakening. The marking can be applied for example by inkjet printing, and substantially simultaneously with the step of introducing the material weakening. Providing a marking makes it easier for the user to quickly locate the material weakening and thus supports the user in separating the different materials.

According to the invention, the sleeve can comprise a label which substantially completely covers the outer side of the sleeve wall. In the embodiment variant already described above, in which a printed material portion extends over the entire length of the sleeve and is guided over the two abutting edges of the sleeve into the receiving space, this material portion already has the function of a label. However, in embodiments in which no material portion or only a narrow, strip-shaped material portion covering the distal end of the sleeve is provided, the sleeve can comprise an additional label which substantially completely covers the outside of the sleeve wall.

The sleeve according to the invention is suitable for example for receiving a film tube filled with a viscous material and can be used to dispense the viscous material into a commercially available cartridge gun. However, the sleeve according to the invention can also be used for other applications, for example as a receptacle for a solid or semi-solid adhesive in a glue stick and therefore as a replacement for the plastics material sleeve otherwise commonly used there. Once the glue stick has been emptied, the outer sleeve can be completely torn open as described above and disposed of separately from the plastics material components of the screw mechanism.

According to claim 11, the invention also relates to a method for producing a sleeve according to one of claims 1 to 10, comprising the following steps:
providing a winding core made of a material comprising fibers;
introducing a material weakening into the sleeve wall with the aid of a cutting tool, wherein the material weakening extends from the distal end into the sleeve wall.

It can be provided that at the same time as a material weakening is introduced into the sleeve wall, a marking indicating the material weakening is applied to the inside of the sleeve wall, for example by inkjet printing.

In a further embodiment of the method according to the invention, it can be provided that, before the material weakening is introduced, a material portion is applied to the winding core, which covers the distal end of the winding core and which abuts both a portion of the inside and a portion of the outside of the sleeve wall, wherein the subsequently introduced material weakening penetrates both the sleeve wall and the material portion, and wherein the marking is applied to the region of the material portion which rests on the inside of the sleeve wall.

The material weakening can, for example, be made in the form of an incision. In an alternative embodiment of the method, the material weakening can be formed in the form of a recess in the sleeve wall, which is delimited by two edge portions which extend at a distance from one another and at different angles from the distal end into the sleeve wall such that they intersect at a point P, wherein the point P has a maximum distance of 1.2 cm from the distal end, and wherein in a subsequent method step a material portion is applied to the winding core, which material portion covers the distal end of the winding core including the recess and which abuts both a portion of the inside and a portion of the outside of the sleeve wall, wherein the material portion has a marking which indicates the position of the recess.

Finally, it can be provided that in a final method step a label is applied to the sleeve which substantially completely covers the outside of the sleeve wall. If the distal end of the sleeve is provided with a material portion acting as abutting edge protection, the label is preferably arranged on the sleeve in such a way that it at least partially covers the portion of the material portion abutting the outer side of the sleeve wall.

The invention is explained in greater detail below on the basis of embodiments and with reference to the accompanying drawings, In the drawings:

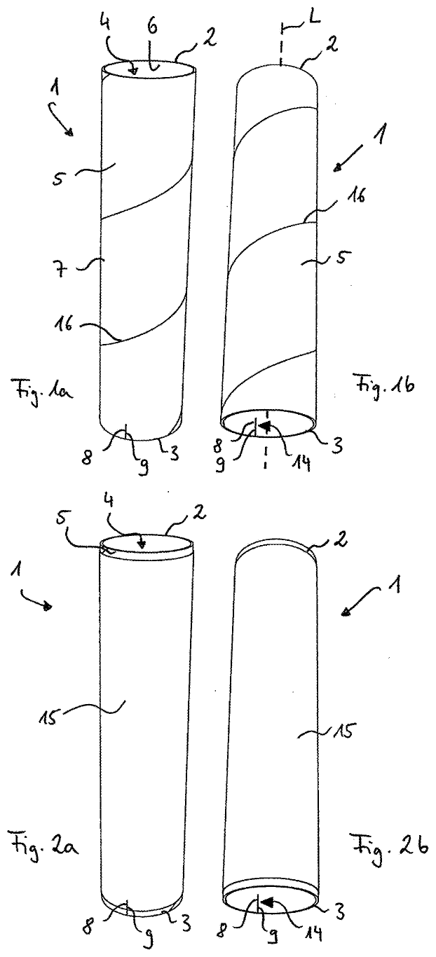

FIGS. 1a and 1b show a sleeve according to a first embodiment of the invention in different perspective views;

FIGS. 2a and 2b show a sleeve according to a second embodiment of the invention in different perspective views;

FIGS. 3a and 3b show a sleeve according to a third embodiment of the invention in different perspective views;

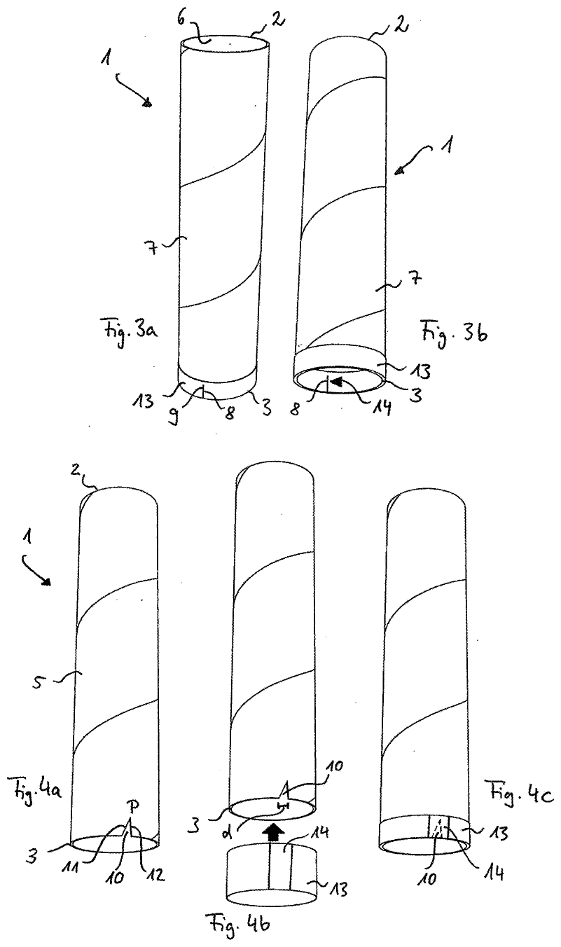

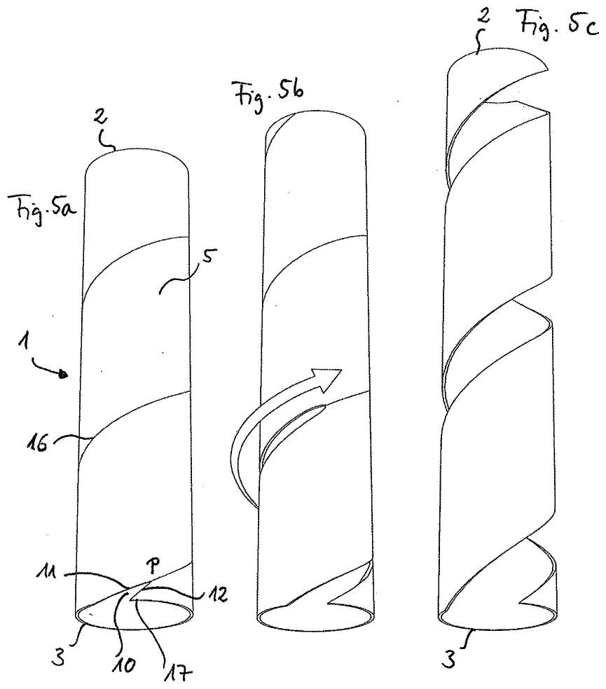

FIGS. 4a, 4b and 4c show a sleeve in further embodiments according to the invention in perspective views;

FIGS. 5a, 5b and 5c show perspective views of a sleeve according to the invention in a sequence of being torn open, that is showing perspective views of a process of tearing open a sleeve according to the invention.

FIGS. 1a and 1b show a sleeve, designated as a whole by 1, for receiving a filling product. The sleeve 1 is made as a winding core from a paper material and can, for example, be used to hold a film tube filled with a viscous material and can be used as a cartridge in a cartridge gun. To form the sleeve 1, a paper or cardboard strip is wound spirally in multiple layers one over the other and is glued accordingly. The abutting edge at which the various winding layers of the paper or cardboard strip abut one another and which extends spirally over the length of the core 1 is referred to as the spiral line 16.

The sleeve 1 has a proximal end 2 and a distal end 3 as well as a sleeve wall 5 extending between the proximal end 2 and the distal end 3 and delimiting a receiving space 4 for the filling product. The proximal end 2 is generally the discharge end of the sleeve 1, to which for example a suitable nozzle element can be connected, while at the distal end 3 a piston can be inserted with the aid of which the filling product can be expelled. The sleeve wall 5 comprises an inner side 6 facing the receiving space 4 as well as an outer side 7 facing away from the receiving space 4.

Starting from the distal end 3, a material weakening 8 formed as an incision 9 extends into the sleeve wall 5. The incision 9 has a length of approximately 1 cm and a cutting width of approximately 0.5 mm and extends substantially in a direction parallel to the longitudinal axis L of the sleeve 1.

The incision 9 serves as a tearing aid for tearing open the sleeve 1 after the contents have been emptied. As soon as the emptying is complete, a user can easily tear the sleeve wall 5 of the sleeve 1 starting at the material weakening 8 until the tear line created in the material of the sleeve wall 5 meets the spiral line 16. Subsequently, the sleeve 1 can be easily separated along the spiral line 16 by further pulling on the paper or cardboard strip. The spiral line 16 here acts as a predetermined breaking point which can be broken by applying a small amount of force. This process is shown in FIGS. 5a to 5c for a further embodiment, which will be explained in more detail below. In this way, it is possible to completely separate the sleeve 1 starting from the distal end 3 to the proximal end 2 and subsequently to separate the entire material of the sleeve 1 from components made of other materials, such as a film tube, a piston and/or a nozzle tip. All of the sleeve material can therefore be provided for paper recycling.

An arrow-shaped marking 14, which is applied by inkjet printing to the inner side 6 of the sleeve wall 5, indicates the tearing aid. The provision of such a marking 14 makes it easier for a user to quickly locate the material weakening and thus supports him in separating the different materials.

FIGS. 2a and 2b show an embodiment of the invention in which the sleeve 1 comprises a label 15 which substantially completely covers the outer side 7 of the sleeve wall 5. In the embodiment shown here, the label 15 extends, to within a few millimeters, to the proximal end 2 and to the distal end 3 of the sleeve 1. The label 15 can be provided with product information in the usual way, for example printed.

In terms of production technology, the label 15 can first be applied to the outer side 7 of the sleeve wall 5 before, in a subsequent step, the incision 9 is made in the composite of the sleeve wall 5 and the label 15. In principle, it is also possible to first make the incision 9 in the material of the sleeve wall 5 and then to apply the label 15 to the outer side 7 of the sleeve wall 5. In the latter case, it is particularly advantageous if a marking 14 on the inner side 6 of the sleeve wall 5 indicates the tearing aid, since this can be at least partially covered by the label 15.

In an embodiment variant not shown in the figures, the label 15 can also be made large enough that it extends beyond the proximal end 2 and the distal end 3 of the sleeve 1 and is folded inwards over these two ends into the receiving space 4 and is brought into contact with the inner side 6 of the sleeve wall 5. In such a design, the material weakening 8 is advantageously not introduced into the composite of sleeve wall 5 and label 15 until after the label 15 has been applied.

FIGS. 3a and 3b show a further embodiment of the invention. Here, only the distal end 3 of the sleeve 1 is covered by a narrow, strip-shaped material portion 13. The material portion 13 covers the lower abutting edge of the sleeve 1 and lies in a narrow region on the outer side 7 and on the inner side 6 of the sleeve wall 5, which is particularly evident from FIG. 3b. The material portion 13 has the function of protecting the otherwise exposed abutting edge of the sleeve 1 at the distal end 3 from the ingress of moisture. The material weakening 8, formed as an incision 9, is incorporated into the composite of sleeve wall 5 and material portion 13. On the inner side 6 of the sleeve wall 5, a marking 14 indicating the material weakening 8 is printed on the material portion 13.

A sleeve 1 according to FIGS. 3a, 3b can additionally comprise a label 15 (not shown here) which substantially completely covers the outer side 7 of the sleeve wall 5 in the manner described above and can also at least partially cover the material portion 13.

FIGS. 4a, 4b, 4c show further embodiments of the invention in which the material weakening 8 is formed as a recess 10 in the sleeve wall 5. The recess 10 is delimited by two edge portions 11, 12 which extend at a distance from one another and at different angles from the distal end 3 into the sleeve wall 5 so that they meet at a point P. The recess 10 thus has a triangular shape. The point P is at a distance of approximately 1 cm from the distal end 3 and the two edge portions 11, 12 have a distance d of approximately 0.6 cm from each other in the region of the distal end 3. In addition, the distal end 3 of the sleeve can be covered by a material portion 13, which can be seen in FIG. 4c. FIG. 4b shows how the material portion 13 is applied to a sleeve according to FIG. 4a. As already described above for the embodiment of FIGS. 3a, 3b, the material portion 13 covers the lower abutting edge of the sleeve 1 and abuts in a narrow region on the outer side 7 and on the inner side 6 of the sleeve wall 5.

In the embodiment of FIGS. 4a-4c, due to the size of the recess 10 it is advantageous if the recess 10 is formed only in the sleeve wall 5 but not in the material portion 13, since otherwise there would be a comparatively high risk of moisture entering the material of the sleeve wall 5 via the edge regions 11, 12. For this reason, the material portion 13 advantageously covers the distal end 3 of the sleeve 1 including the recess 10. In this case, a marking 14 can be arranged on the material portion 13, for example in the form of a stripe having a contrasting color, as shown in FIGS. 4b, 4c. When applying the material portion 13 to the distal end 3, care must be taken to ensure that the material portion 13 is aligned such that the marking 14 lies covering the recess 10, as indicated in FIG. 4 c. A user is thus immediately informed in which region of the distal end 3 the tearing of the material of the sleeve wall 5 can occur without large application of force, in the manner described above.

A sleeve 1 according to FIG. 4c can additionally comprise a label 15 (not shown here) which substantially completely covers the outer side 7 of the sleeve wall 5 in the manner described above and can also at least partially cover the material portion 13.

FIGS. 5a-5c schematically show the process of tearing open a sleeve 1 according to the invention. FIG. 5a shows an embodiment of a sleeve 1 as explained in connection with FIG. 4a. It differs from the embodiment of FIG. 4 a only in that the point P of the recess 10 already lies directly on the spiral line 16 of the sleeve 1. Pulling or tearing at the free end 17 of the sleeve wall 5 thus directly causes a separation of the material of the sleeve wall 5 along the spiral line 16 acting as a predetermined breaking point, as indicated in FIG. 5b, until finally the entire material of the sleeve wall 5 is separated starting from the distal end 3 up to the proximal end 2; see FIG. 5c. In this way the material of the sleeve wall 5 can be completely separated from components made of other materials, for example from a film tube, a nozzle element and a piston, and the different materials can be supplied to the corresponding recycling streams.

What is claimed is:

1. A sleeve (1) for receiving a filling product, wherein the sleeve (1) has a proximal end (2) and a distal end (4), as well as a sleeve wall (5) extending between the proximal end (2) and the distal end (3) and delimiting a receiving space (4) for the filling product, wherein the sleeve wall (5) comprises an inner side (6) facing the receiving space (4) and an outer side (7) facing away from the receiving space (4), and wherein the sleeve (1) is produced as a wound sleeve made of a material comprising fibers, wherein the sleeve (1) comprises a tearing aid in the form of a material weakening (8) that extends from the distal end (3) into the sleeve wall (5).

2. The sleeve (1) according to claim 1, wherein the material weakening (8) extends from the distal end (3) substantially in a direction parallel to the longitudinal axis L of the sleeve (1) over a length of 0.5 cm to 1.2 cm.

3. The sleeve (1) according to claim 1, wherein the material weakening (8) comprises an incision (9) which extends substantially in a direction parallel to the longitudinal axis L of the sleeve (1).

4. The sleeve (1) according to claim 1, wherein the distal end (3) of the sleeve (1) is covered by a material portion (13) which abuts both a portion of the inner side (6) and a portion of the outer side (7) of the sleeve wall (5), wherein the material weakening (8) is formed both in the sleeve wall (5) and in the material portion (13).

5. The sleeve (1) according to claim 4, wherein the material portion (13) substantially completely covers the outer side (7) of the sleeve wall (5), wherein the material portion (13) is printed at least in some regions and has the function of a label.

6. The sleeve (1) according to claim 1, wherein the material weakening (8) comprises a recess (10) in the sleeve wall (5), wherein the recess (10) is delimited by two edge portions (11) and (12) which extend at a distance from one another and at different angles from the distal end (3) into the sleeve wall (5) in such a way that they meet at a point P, wherein the point P is at a maximum distance of 1.2 cm from the distal end (3).

7. The sleeve (1) according to claim 6, wherein the two edge portions (11) and (12) have a distance d of 0.3 cm to 0.8 cm from each other at the distal end (3).

8. The sleeve (1) according to claim 6, wherein the distal end (3) of the sleeve (1) is covered by a material portion (13) which bears against both a portion of the inner side (6) and a portion of the outer side (7) of the sleeve wall (5), wherein the material weakening (8) is formed only in the sleeve wall (5) and the material portion (13) covers the distal end (3) of the sleeve (1) provided with the material weakening (8).

9. The sleeve (1) according to claim 1, wherein the sleeve (1) has a marking (14) indicating the tearing aid.

10. The sleeve (1) according to claim 1, wherein the sleeve (1) comprises a label (15) which substantially completely covers the outer side (7) of the sleeve wall (5).

11. A method for producing a sleeve (1) according to claim 1, comprising the following steps:
providing a winding core made of a material comprising fibers;
introducing a material weakening (8) into the sleeve wall (5) with the aid of a cutting tool, wherein the material weakening (8) extends from the distal end (3) into the sleeve wall (5).

12. The method according to claim 11, wherein, at the same time as a material weakening (8) is introduced into the sleeve wall (5), a marking (14) indicating the material weakening (8) is applied to the inside (6) of the sleeve wall (5).

13. The method according to claim 12, wherein before the material weakening (8) is introduced, a material portion (13) is applied to the winding core, which material portion covers the distal end (3) of the winding core and which abuts both a portion of the inside (6) and a portion of the outside (7) of the sleeve wall (5), wherein the subsequently introduced material weakening (8) penetrates both the sleeve wall (5) and the material portion (13) and wherein the marking (14) is applied to the region of the material portion (13) which abuts the inside of the sleeve wall (5).

14. The method according to claim 11, wherein the material weakening (8) is formed in the form of a recess (10) in the sleeve wall (5), which is delimited by two edge portions (11) and (12) which extend at a distance from one another and at different angles from the distal end (2) into the sleeve wall (5) in such a way that they intersect at a point P, wherein the point P has a maximum distance of 1.2 cm from the distal end (3), and wherein in a subsequent method step a material portion (13) is applied to the winding core, which material portion covers the distal end (3) of the winding core including the recess (10) and which abuts both a portion of the inner side (6) and a portion of the outer side (7) of the sleeve wall (5), wherein the material portion (13) has a marking which indicates the position of the recess (10).

15. The method according to claim 11, wherein in a final method step a label (15) is applied to the sleeve (1) which substantially completely covers the outer side (7) of the sleeve wall (5).
